(19) United States
(12) Patent Application Publication
(10) Pub. No.: US 2025/0167607 A1
(43) Pub. Date: May 22, 2025

(54) CLADDING MAGNET APPLICATION TO CYCLOIDAL MAGNETIC GEARS

(71) Applicant: Ohio State Innovation Foundation, Columbus, OH (US)

(72) Inventors: Marcelo Dapino, Columbus, OH (US); Bradley Losey, Columbus, OH (US); Ismail Nas, Columbus, OH (US)

(21) Appl. No.: 18/950,757

(22) Filed: Nov. 18, 2024

Related U.S. Application Data
(60) Provisional application No. 63/600,111, filed on Nov. 17, 2023.

(51) Int. Cl. H02K 1/27; H02K 51/00

(52) U.S. Cl. CPC H02K 1/27; H02K 51/00; H02K 2213/03

(57) ABSTRACT

An improved magnetic gear is provided that mitigates end-effect loss in cycloidal magnetic gears by adding axially magnetized cladding magnets to the ends of the magnet rotors that redirect the escaping magnetic flux back into the magnetic circuit. The most influential design factors defining the cladding magnet are identified as the height and depth ratio (ratios of dimensions in radial and axial directions, respectively) and the magnetization orientation or tilt of the cladding magnets. The ideal height ratio is found to be approximately 50-60%, while the optimal tilt is around 15 degrees for the cycloidal configuration.

### CROSS-REFERENCE TO RELATED APPLICATIONS

This application claims priority to and benefit of U.S. Provisional Patent Application Ser. No. 63/600,111, filed Nov. 17, 2023, and titled “CLADDING MAGNET APPLICATION TO CYCLOIDAL MAGNETIC GEARS.” The disclosure of which is hereby incorporated by reference in its entirety.

### STATEMENT OF GOVERNMENT SUPPORT

This invention was made with government support under 1738723 awarded by the National Science Foundation. The government has certain rights in the invention.

### BACKGROUND

Magnetic gears enable transmission through permanent magnet interactions without physical contact, reducing noise, vibration, and the need for lubrication and frequent maintenance. A design challenge with magnetic gears is the torque transmission inefficiency due to end-effect loss, which occurs when the magnetic flux leaks axially into the surrounding air and fails to couple between the rotors.

### SUMMARY

This application proposes mitigating end-effect loss in cycloidal magnetic gears by adding axially magnetized cladding magnets to the ends of the magnet rotors, redirecting the escaping magnetic flux back into the magnetic circuit. The most influential design factors defining the cladding magnet are identified as the height and depth ratio (ratios of dimensions in radial and axial directions, respectively) and the magnetization orientation or tilt of the cladding magnets. The ideal height ratio is found to be approximately 50-60%, while the optimal tilt is around 15 degrees for the cycloidal configuration.

In some aspects, the techniques described herein relate to a magnetic gear including: a magnetic outer rotor; a magnetic inner rotor; a first array of cladding magnets disposed at a first axial end of the magnetic inner rotor; and a second array of cladding magnets disposed at a first axial end of the magnetic outer rotor.

In some aspects, the techniques described herein relate to a magnetic gear, further including: a third array of cladding magnets disposed at a second axial end of the magnetic inner rotor; and a fourth array of cladding magnets disposed at a second axial end of the magnetic outer rotor.

In some aspects, the techniques described herein relate to a magnetic gear, wherein the first array and second arrays cap magnetic flux at the first and second axial ends of the magnetic inner rotor and the magnetic outer rotor.

In some aspects, the techniques described herein relate to a magnetic gear, wherein the first array and the second array each include a plurality of axially directed magnets, each axially directed magnet positioned over a pole of the magnetic inner rotor and a pole of the magnetic outer rotor.

In some aspects, the techniques described herein relate to a magnetic gear, wherein the magnets in the first array of magnets and the second array of magnets each have a tilt of about 15°.

In some aspects, the techniques described herein relate to a magnetic gear, wherein the magnets in the first array of magnets and the second array of magnets each have a tilt between 0° and 90°.

In some aspects, the techniques described herein relate to a magnetic gear, wherein the magnetic gear includes a cycloidal magnetic gear.

In some aspects, the techniques described herein relate to an aircraft including the magnetic gear.

In some aspects, the techniques described herein relate to a wind turbine including the magnet gear.

In some aspects, the techniques described herein relate to a vehicle including the magnetic gear.

In some aspects, the techniques described herein relate to a spacecraft including the magnetic gear.

In some aspects, the techniques described herein relate to a system including: a magnetic gear including a magnetic outer rotor and a magnetic inner rotor; a first array of cladding magnets disposed at a first axial end of the magnetic inner rotor; and a second array of cladding magnets disposed at a first axial end of the magnetic outer rotor.

In some aspects, the techniques described herein relate to a system, further including: a third array of cladding magnets disposed at a second axial end of the magnetic inner rotor; and a fourth array of cladding magnets disposed at a second axial end of the magnetic outer rotor.

In some aspects, the techniques described herein relate to a system, wherein the first array and second arrays cap magnetic flux at the first and second axial ends of the magnetic inner rotor and the magnetic outer rotor.

In some aspects, the techniques described herein relate to a system, wherein the first array and the second array each include a plurality of axially directed magnets, each axially directed magnet positioned over a pole of the magnetic inner rotor and a pole of the magnetic outer rotor.

In some aspects, the techniques described herein relate to a system, wherein the magnets in the first array of magnets and the second array of magnets each have a tilt of about 15°.

In some aspects, the techniques described herein relate to a system, wherein the magnets in the first array of magnets and the second array of magnets each have a tilt between 0° and 90°.

In some aspects, the techniques described herein relate to a system, wherein the magnetic gear includes a cycloidal magnetic gear.

In some aspects, the techniques described herein relate to a wind turbine including the system.

In some aspects, the techniques described herein relate to a vehicle including the system.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example cycloidal magnetic gear 100.

FIG. 2 shows three possible flux paths around the inner rotor 105 and the outer rotor 107 of a magnetic gear.

FIG. 3 is an illustration showing cladding magnets mounted on one half of a magnetic rotor.

FIG. 4 is an illustration of another example embodiment where continuous cladding magnetic rings 121 have been added to the tops of the inner magnetic rotor 105 and the outer magnetic rotor 107.

FIG. 5 is an illustration of the change in direction of the magnetic flux resulting from the application of the cladding magnets 120 to the top surfaces of the inner magnetic rotor 105 and the outer magnetic rotor 107.

FIG. 6 illustrates the variables that define the cladding magnet design 120 used in the magnetic gear 100.

FIG. 7 is an illustration of a magnetic rotor with a plurality of cladding magnets 120 arranged in a Halbach array.

FIG. 8 is an illustration of a magnetic rotor before and after the cladding magnetic modification described herein.

FIG. 9 is an illustration of a graph showing the relationship between height ratio, depth, and specific torque for the cladding magnets 120.

FIG. 10 is an illustration of a graph showing the relationship between tilt angle and torque for the cladding magnets 120.

### DETAILED DESCRIPTION

### I. Introduction

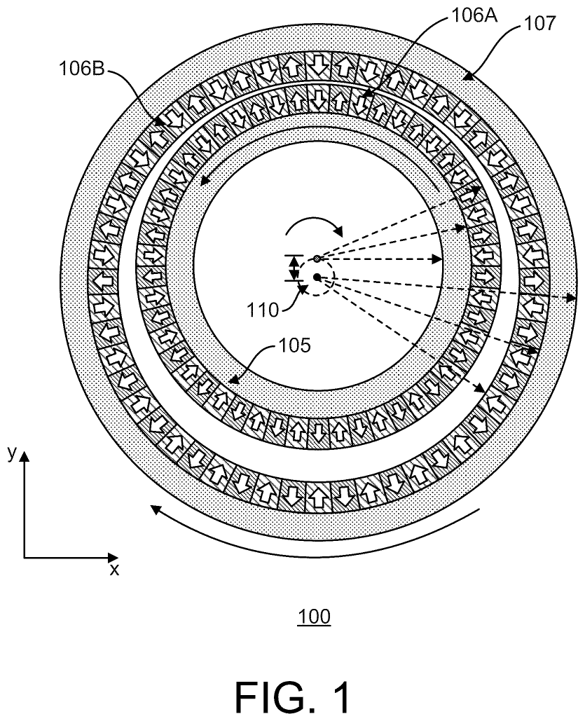

FIG. 1 is an illustration of an example cycloidal magnetic gear 100. As shown, the cycloidal magnetic gear 100 includes an outer magnetic rotor 107 and an inner magnetic rotor 105. As shown by the directional arrows, the inner rotor 105 rotates eccentrically about its own axis in a counter-clockwise direction while the outer rotor's rotation about a central gear axis 110 is clockwise.

The cycloidal magnetic gear 100 transmits torque and speed through electromagnetic interaction between the inner magnetic rotor 105 and the outer magnetic rotor 107. As shown, each of the inner magnetic rotor 105 and the outer magnetic rotor 107 includes an array of magnets 106 (i.e., the array of magnets 106A and 106B). Depending on the embodiment, the inner magnetic rotor 105 and the outer magnetic rotor 107 may be constructed using a permanent magnet.

The directions of the remanent magnetic flux from the arrays of magnets 106 are illustrated by the directional arrows. The array of magnets 106A are applied to the outside of the inner magnetic rotor 105. The array of magnets 106B are applied to the inside of the outer magnetic rotor 107. Note that unlike coaxial magnetic gears, the cycloidal magnetic gear 100 does not require or use a flux modulator.

Advantages of magnetic gears, such as the cycloidal magnetic gear 100, include low noise and vibration, reduced maintenance, and inherent overload protection. Through the use of rare-earth materials such as NdFeB magnets and permanent magnet configurations such as Halbach arrays, the performance of magnetic gears is high enough to make them attractive alternatives to certain types of mechanical gears.

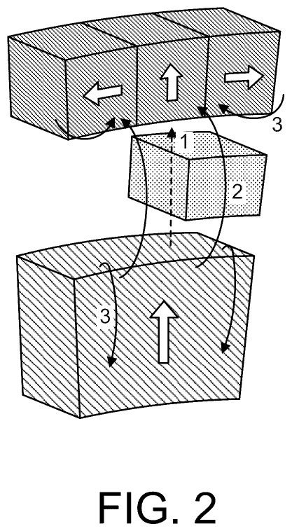

The arrangement of components within a magnetic gear results in several available magnetic flux paths. FIG. 2 shows three possible paths in a coaxial magnetic gear, but the paths are generally applicable to the cycloidal magnetic gear 100 described herein. Path 1 represents the coupled magnetic flux contributing to the torque output of a magnetic gear; it is composed of a desired average torque and an undesired torque ripple component.

Path 2 represents magnetic flux flowing through the air across the end of the magnetic gear (fringing), essentially a region of reduced flux density that provides an inefficient contribution to torque transmission. Another source of loss (leakage) is represented by path 3 where the magnetic flux returns to its originating permanent magnet pole without coupling and without contributing to torque transmission. The magnetic flux flowing in paths 2 and 3 collectively make up the end-effect loss, which is known to cause an output torque loss of roughly 10-40% for magnetic gear topologies.

Flux leakage issue and mitigation concepts have been studied for other types of electric machines. Xu et al. investigated the severity of radial flux leakage for a permanent magnet motor and proposed a new flux leakage controllable permanent magnet motor to address the issue. By introducing a flux barrier design around the permanent magnet rotor, torque output is improved especially at heavy loading conditions of the machine within cyclic loading. Diab et al. presented a quasi-3D reluctance network model with end-effects on an axial flux focusing magnetic gear, to quantify the torques and forces induced by the gear more accurately accounting for the reductions due to end effects. Alternatively, Gardner et al. found that end-effect loss in cycloidal magnetic gears can lead to a reduction in torque ranging from 5 to 20% in cycloidal magnetic gears. Machines with larger outer diameter and shorter axial dimension are more prone to this loss since their edge portions experience severe leakage, which dominates over the relatively uniform field distribution at the axial center of the machine. Accurate prediction of torque reduction due to end-effect loss requires 3D finite element computation, as 2D analysis fails to consider the gradient of flux along the axial direction and may overestimate torque.

### II. Cladding Magnet Concept

End effects lead to a reduction of the torque output from a cycloidal magnetic gear 100 by 10% to 40% depending on the specific design and aspect ratio. Conventional cycloidal magnetic gear designs have traditionally been based on 2D analysis performed on axially uniform rotors. This approach is suboptimal for 3D design as it overlooks the axial flux paths into the surrounding air and the associated loss of transmitted torque.

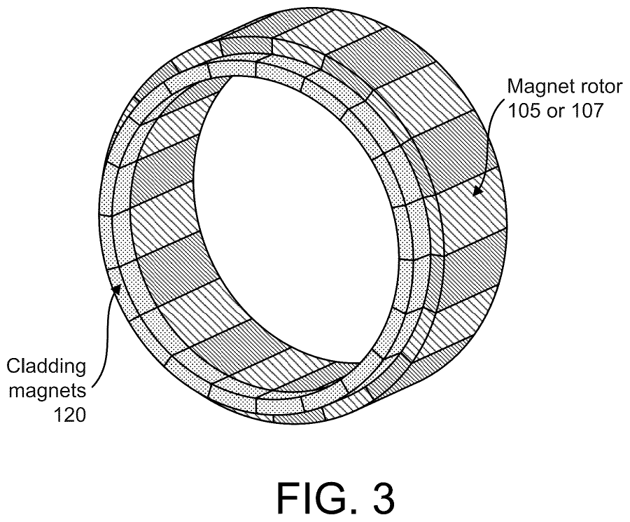

Modifying the orientation of the magnetization vector at the axial ends of the cycloidal magnetic gear 100 to manipulate the field is a viable solution to this problem. In one embodiment, cladding magnets are installed along the axial direction of the cycloidal magnetic gear 100 to introduce a second source of magnetic potential that is oriented to counteract magnetic flux leakage and mitigate the end-effect loss. An embodiment showing redirection of magnetic flux by introduction of cladding magnets is shown in FIG. 3.

In the example shown in FIG. 3, a plurality of cladding magnets 120 have been added to the top of a magnetic rotor of the cycloidal magnetic gear 100. The magnetic rotor could be either or both of the inner magnetic rotor 105 or the outer magnetic rotor 107. Example cladding magnets may include neodymium magnets. Other types of cladding magnets 120 may be used. While not shown, a set of cladding magnets 120 may be similarly added to the bottom or opposite side of the magnetic rotor.

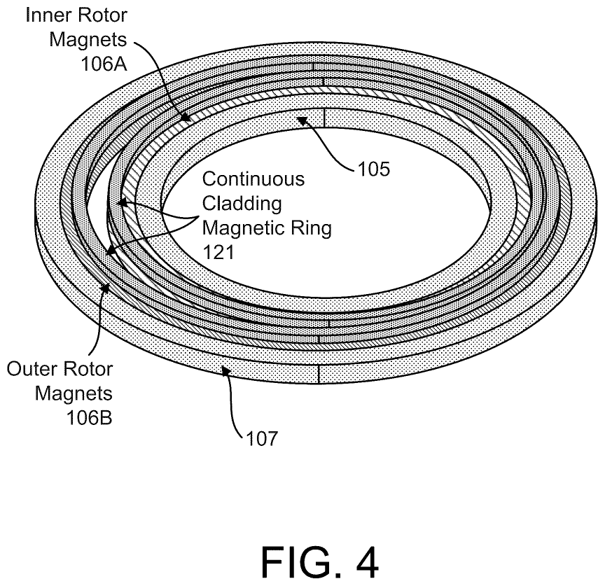

FIG. 4 is an illustration of another example embodiment where a continuous cladding magnetic ring 121 is added to the tops of the inner magnetic rotor 105 and the outer magnetic rotor 107. As shown, a continuous cladding magnetic ring 121 has been applied to each of the tops of the inner rotor magnets 106A and the outer rotor magnets 106B of the outer magnetic rotor 107 and the inner magnetic rotor 105, respectively. While not shown, continuous cladding magnetic rings 121 may be similarly added to the bottom or opposite sides of the magnetic rotors 105 and 107. Depending on the embodiment, an array of cladding magnets 120 may be used in place of each continuous cladding magnetic ring 121, and vice versa.

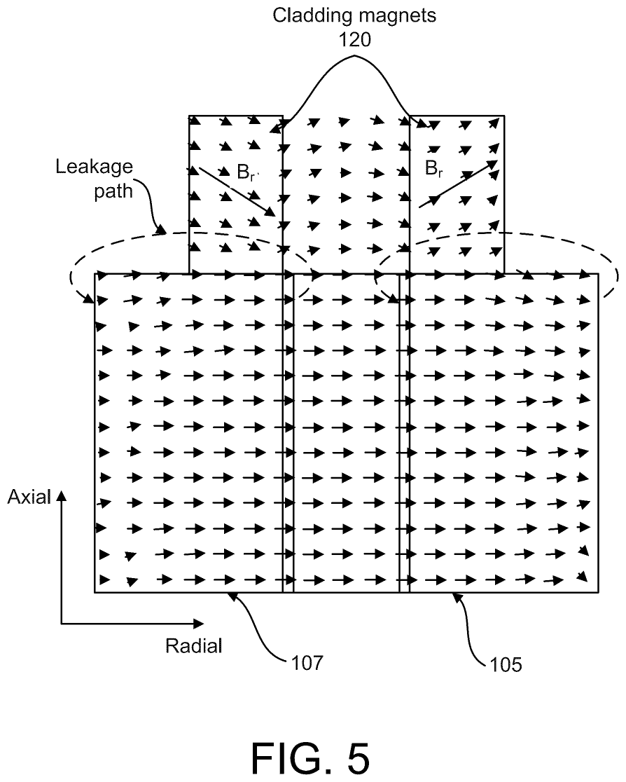

FIG. 5 is an illustration of the change in direction of the magnetic flux resulting from the application of the cladding magnets 120 (or continuous cladding magnetic ring 121) to the top surfaces of the inner magnetic rotor 105 and the outer magnetic rotor 107. Although the adjacent rotor's permanent magnets are only magnetized within the radial plane (shown by the small arrows), the remanent flux density vector of the cladding magnet arrays 120 (Bᵣ) has a component that is oriented in the axial direction. When the magnetization in the cladding magnets 120 aligns with the leaking flux, it results in the reversal of some of the leaking flux (depicted by the hashed arrows). This reversal causes the leaking flux to couple with the inner rotor 105 through the space between the rotors 105 and 107.

The implementation of cladding magnets 120 applied to the rotors 105 and 107 may take into account the magnetic configuration of the rotors 105 and 107. A classical approach to design magnetic gears involves using Halbach arrays with multiple pole pairs within each magnetic rotor and multiple magnet pieces per pole pair. To achieve the best redirection of flux back into the cycloidal magnetic gear 100, the magnetization orientation of the cladding magnets 120 may also be considered. In addition, the design becomes more complex due to the inversion of the Halbach cylinder used for the inner rotor. In this discussion, the geometry of the cladding magnets 120 are parameterized with several variables related to the properties of a central portion of the magnetic gear 100 for a systematic analysis.

### III. Cladding Magnet Geometry

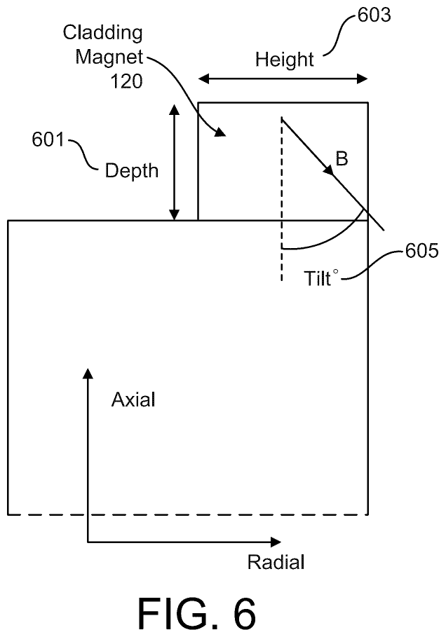

The variables that define the cladding magnet design 120 are shown in FIG. 6. These include axial depth 601, radial height 603, and magnetization tilt 605. Axial depth 601 describes the length of the cladding magnets 120 in the axial direction. Radial height 603 refers to the radial dimension of the cladding magnets 120. Since the magnets of the inner magnetic rotor 105 and the outer magnetic rotor 107 may have different radial thicknesses, a height ratio is introduced to scale the inner cladding magnets 106A and outer cladding magnets 106B heights to cover a portion of their corresponding radial magnetic rotor. Tilt 605 is defined as the angle that the cladding magnets' 120 magnetization vector makes relative to the axial direction of the cycloidal magnetic gear 100. The tilt of each rotor's cladding magnets is defined such that when the tilt angle is between 0° and 90°, both sets of cladding magnets 120 are magnetized towards a gap between the two rotors.

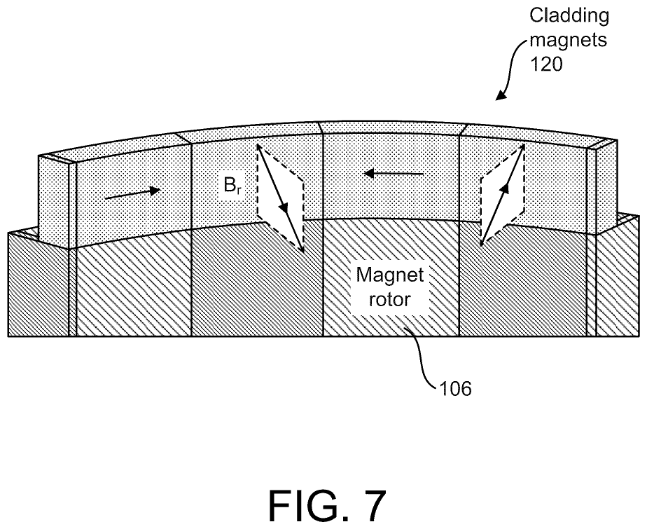

In some embodiments, the cladding magnets 120 are located on top of the standard radial magnets of the rotors 106 as close as possible to their respective air gaps. They are positioned as such to minimize reluctance between them and the opposite rotor and are arranged in a Halbach array configuration to concentrate flux towards the air gap of the gear 100. This arrangement is represented in FIG. 7.

### IV. Parametric Analyses

Computational parametric sweeps were conducted as a function of the cladding magnet 120 parameters defined in the previous section. To ensure a fair comparison between a cladded cycloidal magnetic gear 100 and its uncladded counterpart, the total mass of the gear 100 was maintained constant. This is because the specific torque of a cycloidal magnetic gear 100 scales with the magnetically-active mass of the cycloidal gear 100. Therefore, comparing the specific torque of cycloidal magnetic gears 100 with different masses would be misleading, as it would favor the heavier cladded machine over the uncladded one.

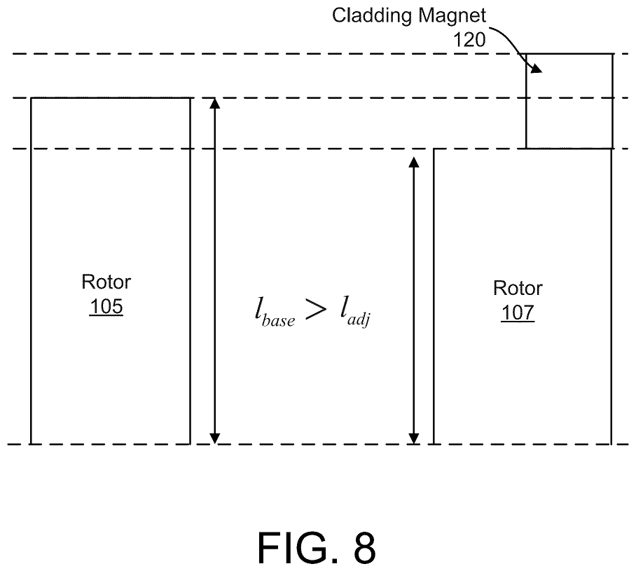

To maintain a consistent total mass after adding the cladding magnets 120, the axial length of the magnetic gear 100 was decreased. This reduction in length enables the other geometric variables and their corresponding performance parameters to remain unchanged, facilitating meaningful comparisons. The adjustment is shown in FIG. 8. Note that the length adjustment is only performed to maintain consistent mass between the cladded and uncladded magnetic gears to allow for comparison. Cladding magnets 120 may be added to cycloidal magnetic gears without any length or mass adjustment to the cycloidal magnetic gears.

A multivariable parametric study was conducted on a generic cycloidal magnetic gear design, defined in the table I below, where height ratio, depth and tilt parameters were varied in order to investigate the improvement of specific torque due to incorporation of cladding magnets 120. The geometry of the design assumed for the parametric studies is shown in FIG. 4.

TABLE I
Parameters defining the cycloidal
magnetic gear 100 geometry

| Parameter | Value | |
|---|---|---|
| Gear Ratio | 71 | |
| Inner Pole-Pairs | 70 | |
| Outer Pole-Pairs | 71 | |
| Magnets per Inner | 4 | |
| Pole-Pair | | |
| Magnets per Outer | 4 | |
| Pole-Pair | | |
| Outer Radius | 129 | mm |
| Outer Magnet Thickness | 3 | mm |
| Inner Magnet Thickness | 3 | mm |
| Air Gap Thickness | 1 | mm |
| Axis Offset | 3 | mm |
| Axial Length | 25.4 | mm |
| Weight | 0.355 | kg |
| 3D Specific Torque | 58.85 | N*m/kg |
| 3D Torque | 20.89 | N*m |
| 2D Torque | 21.10 | N*m |

| | |
|---|---|
| End-Effect Factor | 98.9 |

The model is symmetric about the central transverse plane and a conservatively large axial air domain is defined to quantify end-effects. Halbach array magnetization is utilized into all magnet rotors and a nonlinear ferromagnetic material is used.

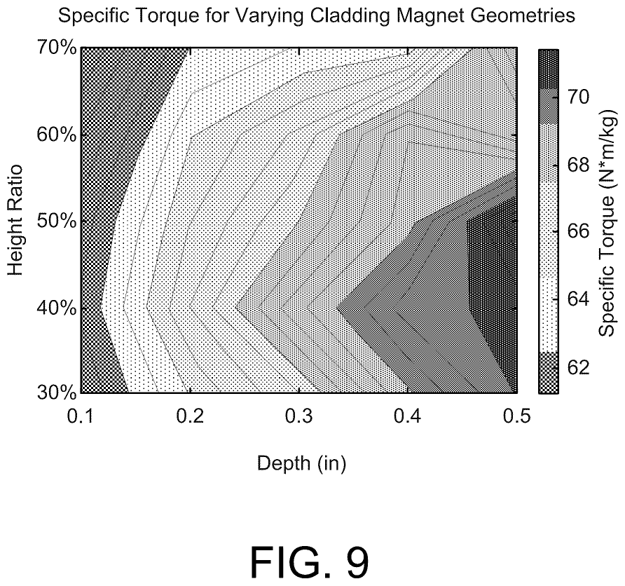

The results from this study show that applying cladding magnets 120 improves the specific torque capacity of cycloidal magnetic gears compared to the uncladded version, although the trend does not present a global peak where optimal cladding magnet parameters can be reported. The results from the study where height and depth dimensions were varied are presented in FIG. 9, in which general trend shows that introducing cladding magnets with a depth of 0.5″ (5.08 mm) and height ratio of 50% improves the specific torque by 22.2%.

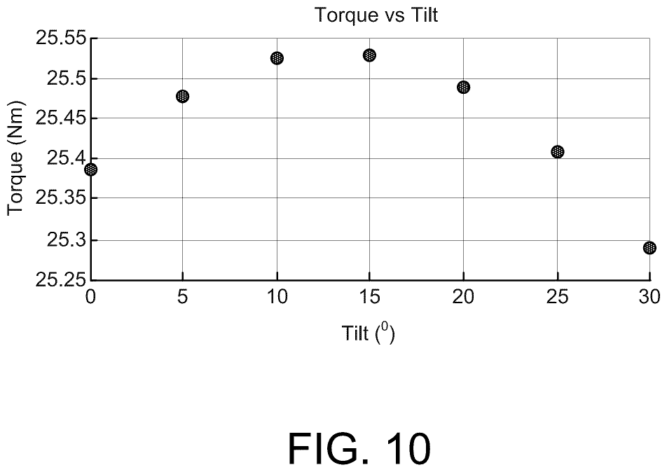

The results of a study of torque where tilt angle is varied is shown in FIG. 10. The study shows that the optimal tilt value is around 15°, which can be attributed to the absence of a modulator rotor. For the cycloidal geometry, the electromagnetic coupling is directly between the magnetic inner rotor 105 and the magnetic outer rotor 107, hence the optimal magnetization angle of cladding magnets 120 is pointed to the air gap of the gear 100.

The overall determined optimal parameters values for the magnetic cycloidal gear 100 are described below in the table II.

TABLE II
Optimal Parameters Defining the
Cladding Magnet Domain for the
Cycloidal Magnetic Gear 100.

| Parameter | Value | |
|---|---|---|
| Height Ratio | 50% | |
| Depth | 12.54 | |
| Tilt | 15 | |
| Adjusted Axial Length | 12.70 | mm |
| Weight | 0.355 | kg |

| | |
|---|---|
| 3D Torque | 25.53 |
| Specific Torque | 71.92 |
| Specific Torque | 22.2% |
| Improvement | |

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A magnetic gear comprising:
a magnetic outer rotor;
a magnetic inner rotor;
a first array of cladding magnets disposed at a first axial end of the magnetic inner rotor; and
a second array of cladding magnets disposed at a first axial end of the magnetic outer rotor.

2. The magnetic gear of claim 1, further comprising:
a third array of cladding magnets disposed at a second axial end of the magnetic inner rotor; and
a fourth array of cladding magnets disposed at a second axial end of the magnetic outer rotor.

3. The magnetic gear of claim 1, wherein the first array and second arrays cap magnetic flux at the first and second axial ends of the magnetic inner rotor and the magnetic outer rotor.

4. The magnetic gear of claim 1, wherein the first array and the second array each include a plurality of axially directed magnets, each axially directed magnet positioned over a pole of the magnetic inner rotor and a pole of the magnetic outer rotor.

5. The magnetic gear of claim 1, wherein the magnets in the first array of magnets and the second array of magnets each have a tilt of about 15°.

6. The magnetic gear of claim 1, wherein the magnets in the first array of magnets and the second array of magnets each have a tilt between 0° and 90°.

7. The magnetic gear of claim 1, wherein the magnetic gear comprises a cycloidal magnetic gear.

8. An aircraft comprising the magnetic gear of claim 1.

9. A wind turbine comprising the magnet gear of claim 1.

10. A vehicle comprising the magnetic gear of claim 1.

11. A spacecraft comprising the magnetic gear of claim 1.

12. A system comprising:
a magnetic gear comprising a magnetic outer rotor and a magnetic inner rotor;
a first array of cladding magnets disposed at a first axial end of the magnetic inner rotor; and
a second array of cladding magnets disposed at a first axial end of the magnetic outer rotor.

13. The system of claim 12, further comprising:
a third array of cladding magnets disposed at a second axial end of the magnetic inner rotor; and
a fourth array of cladding magnets disposed at a second axial end of the magnetic outer rotor.

14. The system of claim 12, wherein the first array and second arrays cap magnetic flux at the first and second axial ends of the magnetic inner rotor and the magnetic outer rotor.

15. The system of claim 12, wherein the first array and the second array each include a plurality of axially directed magnets, each axially directed magnet positioned over a pole of the magnetic inner rotor and a pole of the magnetic outer rotor.

16. The system of claim 12, wherein the magnets in the first array of magnets and the second array of magnets each have a tilt of about 15°.

17. The system of claim 12, wherein the magnets in the first array of magnets and the second array of magnets each have a tilt between 0° and 90°.

18. The system of claim 12, wherein the magnetic gear comprises a cycloidal magnetic gear.

19. A wind turbine comprising the system of claim 12.

20. A vehicle comprising the system of claim 12.
